(19) United States
(12) Patent Application Publication
(10) Pub. No.: US 2022/0117200 A1
(43) Pub. Date: Apr. 21, 2022

(54) Pet Leash Tension Shock Apparatus

(71) Applicant: Paul Fronapfel, Charlotte, NC (US)

(72) Inventor: Paul Fronapfel, Charlotte, NC (US)

(21) Appl. No.: 17/072,218

(22) Filed: Oct. 16, 2020

(51) Int. Cl. A01K 27/00; A01K 15/02

(52) U.S. Cl. CPC A01K 27/009; A01K 27/001; A01K 27/003; A01K 15/029

(57) ABSTRACT

A pet leash tension shock apparatus for training pets not to pull on a leash includes a collar and a buckle coupled to the collar. A pair of electrodes is coupled a collar inside. An electric connector is coupled to the pair of electrodes. A leash is coupled to a leash connector coupled to the collar. A tensiometer is coupled within the leash to measure tensile force within the leash. A feeder wire is coupled within the leash and is in operational communication with the tensiometer. A controller is coupled to the leash. The controller is in operational communication with the feeder wire and has a battery to deliver an electric shock to a pet through the pair of electrodes when the tensiometer senses tensile force within the leash above a preset threshold.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pet leash training devices and more particularly pertains to a new pet leash training device for training pets not to pull on a leash.

### (2) Description of Related Art Including Information Disclosed Under 37 CFR 1.97 and 1.98

The prior art relates to pet leash training devices. Known devices have integrated tensiometers to deliver a shock to a pet, yet do not have a means of separating from the collar. These devices also like a controller to apply either different fixed shock levels or a variable shock level correlated to the tension in the tensiometer. Known devices also have a separate tensiometer rather than a tensiometer integrated into the body of the leash.

### BRIEF SUMMARY OF THE INVENTION

An embodiment of the disclosure meets the needs presented above by generally comprising a collar having a collar outside, a collar inside, a collar first end, and a collar second end. A buckle is coupled to the collar. The buckle selectively engages the collar first end and the collar second end. A pair of electrodes is coupled to the collar. Each electrode is coupled to the collar inside. An electric connector is coupled to the pair of electrodes. A leash connector is coupled to the collar. A leash is coupled to the leash connector. The leash has a distal end coupled to the leash connector and a looped proximal end. A tensiometer is coupled within the leash. The tensiometer is in operational communication with the electric connector. The tensiometer measures tensile force within the leash between the distal end and the proximal end. A feeder wire is coupled within the leash. The feeder wire is in operational communication with the tensiometer and extends towards the proximal end of the leash. A controller is coupled to the leash. The controller is in operational communication with the feeder wire and has a battery to deliver an electric shock to a pet through the pair of electrodes when the tensiometer senses tensile force within the leash above a preset threshold.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a pet leash tension shock apparatus according to an embodiment of the disclosure.

FIG. 2 is a top plan view of an embodiment of the disclosure.

FIG. 3 is a side elevation view of an embodiment of the disclosure.

FIG. 4 is an isometric detail view of an embodiment of the disclosure.

FIG. 5 is an in-use view of an embodiment of the disclosure.

### DETAILED DESCRIPTION OF THE INVENTION

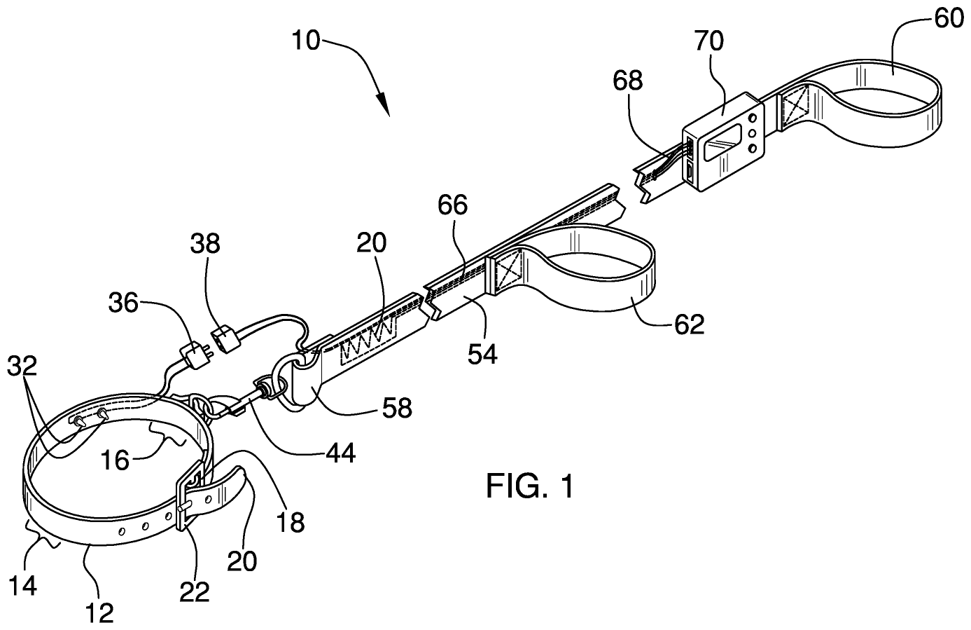

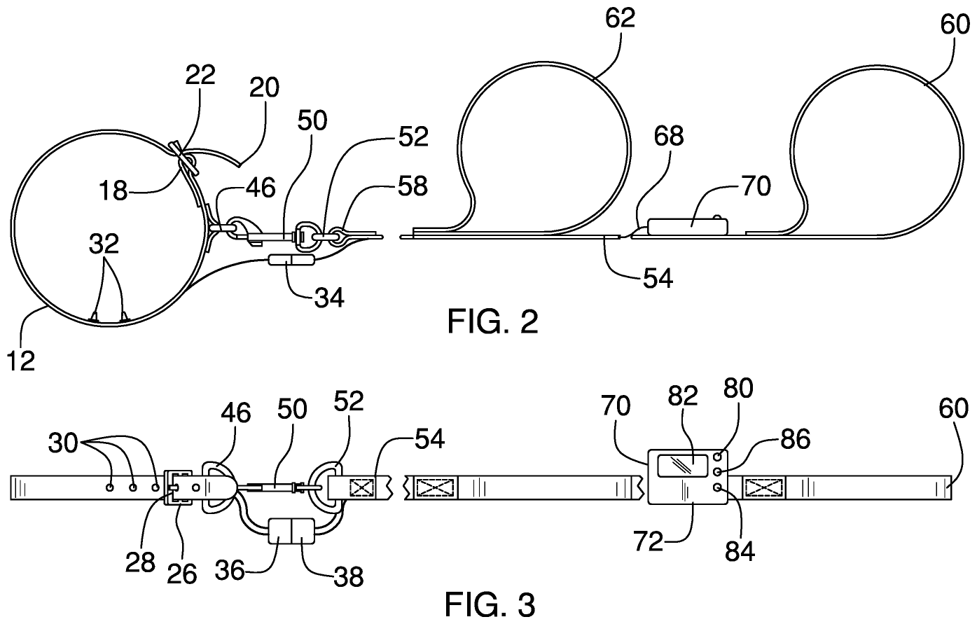

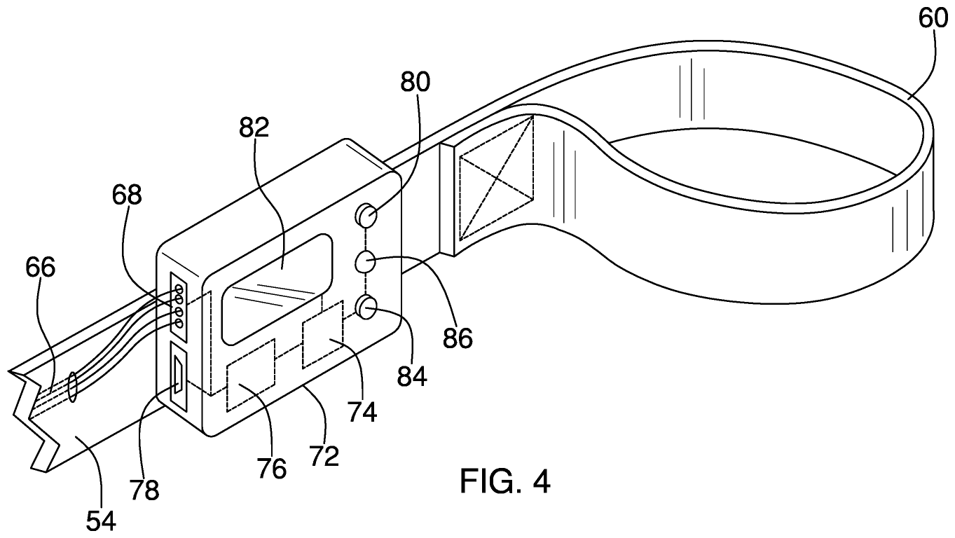

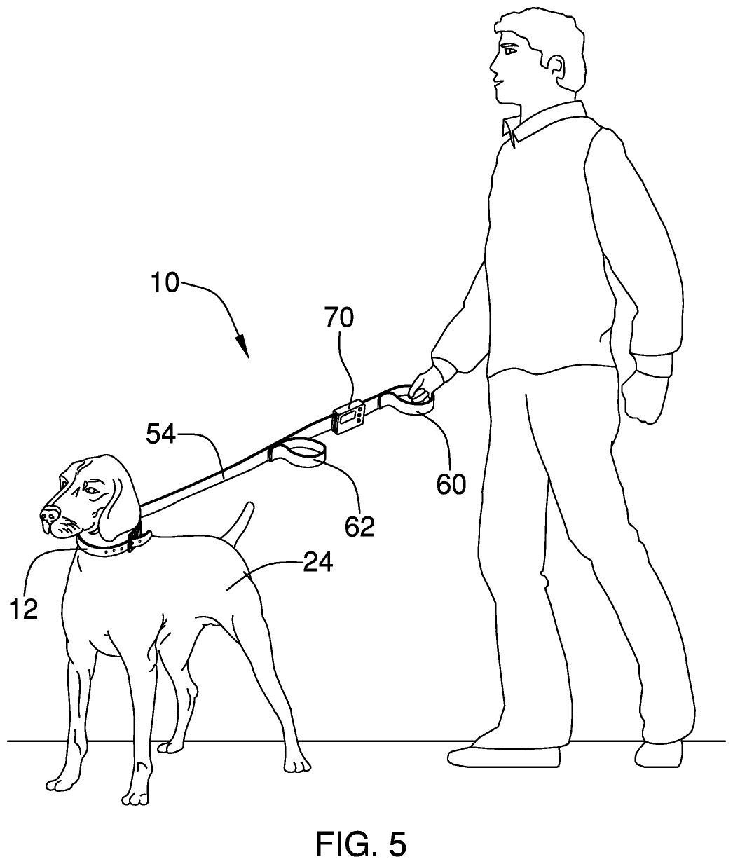

With reference now to the drawings, and in particular to FIGS. 1 through 5 thereof, a new pet leash training device embodying the principles and concepts of an embodiment of the disclosure and generally designated by the reference numeral 10 will be described.

As best illustrated in FIGS. 1 through 5, the pet leash tension shock apparatus 10 generally comprises a collar 12 having a collar outside 14, a collar inside 16, a collar first end 18, and a collar second end 20. A buckle 22 is coupled to the collar 12. The buckle 22 selectively engages the collar first end 18 and the collar second end 20 to allow the collar 12 to be worn by a pet 24. The buckle 22 may include a frame 26 and a post 28 to engage a plurality of adjustment apertures 30 extending through the collar 12.

A pair of electrodes 32 is coupled to the collar 12. Each electrode 32 is coupled to the collar inside 16 to directly contact the pet 24. An electric connector 34 is coupled to the pair of electrodes 32. The electric connector 34 may include a male plug 36 coupled to the pair of electrodes 32 and a female plug 38. The male plug 36 is selectively engageable with the female plug 38.

A leash connector 44 is coupled to the collar 12. The leash connector 44 may include a first D-ring 46 coupled to the collar outside 14. A pivot clip 50 is selectively engaged with the first D-ring 46 and a second D-ring 52 coupled to the pivot clip 50. A leash 54 is coupled to the leash connector 44. The leash 54 has a distal end 58 coupled to the second D-ring 52 of the leash connector and a looped proximal end 60. There may be a mid-leash handle 62 coupled to the leash 54. The mid-leash handle 62 may be a loop to allow the user to secure the pet 24 closer to the collar 12.

A tensiometer 64 is coupled within the leash 54. The tensiometer 64 is in operational communication with the female plug 38 of the electric connector 34. The tensiometer 64 measures tensile force within the leash 54 between the distal end 58 and the proximal end 60. A feeder wire 66 is coupled within the leash 54 and is in operational communication with the tensiometer 64. The feeder wire 66 extends towards the proximal end 60 of the leash and may have a wire harness 68 extending from within the leash 54 to a controller 70.

The controller 70 is coupled to the leash 54 and is in operational communication with the feeder wire 66. The controller 70 may comprise a housing 72 coupled to the leash 54. A microcontroller 74 may be coupled within the housing 72 and in operational communication with the tensiometer 64. A battery 76 is coupled within the housing 72 and is in operational communication with the feeder wire 66 and the microcontroller 74 to deliver an electric shock to a pet through the pair of electrodes 32 when the tensiometer 64 senses tensile force within the leash 54 above a preset threshold. A charging port 78 is coupled to the housing 72 and is in operational communication with the battery 76. A power button 80 is coupled to the housing 72 and is in operational communication with the battery 76. An LED screen 82 may be coupled to the housing 72 and is in operational communication with the microcontroller 74. A control button 84 is coupled to the housing 72 and is in operational communication with the microcontroller 74 to adjust the shock level delivered to the pair of electrodes 32. An indicator light 86 may be coupled to the housing 72 and is in operational communication with the microcontroller 74 to show when the controller 70 is powered on and when a shock is being delivered.

In use, the controller 70 is turned on and set to a desired power level, or to a variable power level depending on the amount of tension detected by the tensiometer 64. The pet 24 may thus be trained to not pull on the leash 54.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pet leash tension shock apparatus comprising:
a collar having a collar outside, a collar inside, a collar first end, and a collar second end;
a buckle coupled to the collar, the buckle selectively engaging the collar first end and the collar second end;
a pair of electrodes coupled to the collar, each electrode being coupled to the collar inside;
an electric connector coupled to the pair of electrodes;
a leash connector coupled to the collar;
a leash coupled to the leash connector, the leash having a distal end coupled to the leash connector and a looped proximal end;
a tensiometer coupled within the leash, the tensiometer being in operational communication with the electric connector, the tensiometer measuring tensile force within the leash between the distal end and the proximal end;
a feeder wire coupled within the leash, the feeder wire being in operational communication with the tensiometer and extending towards the proximal end of the leash; and
a controller coupled to the leash, the controller being in operational communication with the feeder wire, the controller having a battery to deliver an electric shock to a pet through the pair of electrodes when the tensiometer senses tensile force within the leash above a preset threshold.

2. The pet leash tension shock apparatus of claim 1 further comprising the leash connector including a first D-ring coupled to the collar outside, a pivot clip selectively engaged with the first D-ring, and a second D-ring coupled to the pivot clip and the distal end of the leash.

3. The pet leash tension shock apparatus of claim 1 further comprising a mid-leash handle coupled to the leash.

4. The pet leash tension shock apparatus of claim 1 further comprising the electric connector including a male plug coupled to the pair of electrodes and a female plug coupled to the tensiometer, the male plug being selectively engageable with the female plug.

5. The pet leash tension shock apparatus of claim 1 further comprising the feeder wire having a wire harness extending from within the leash to the controller.

6. The pet leash tension shock apparatus of claim 1 further comprising the controller comprising:
a housing coupled to the leash;
a microcontroller coupled within the housing, the microcontroller being in operational communication with the tensiometer;
the battery being coupled within the housing and in operational communication with the feeder wire and the microcontroller;
a charging port coupled to the housing, the charging port being in operational communication with the battery; and
a power button coupled to the housing, the power button being in operational communication with the battery.

7. The pet leash tension shock apparatus of claim 6 further comprising an LED screen coupled to the housing, the LED screen being in operational communication with the microcontroller; a control button coupled to the housing, the control button being in operational communication with the microcontroller to adjust the shock level delivered to the pair of electrodes.

8. The pet leash tension shock apparatus of claim 6 further comprising an indicator light coupled to the housing, the indicator light being in operational communication with the microcontroller.

9. A pet leash tension shock apparatus comprising:
a collar having a collar outside, a collar inside, a collar first end, and a collar second end;
a buckle coupled to the collar, the buckle selectively engaging the collar first end and the collar second end;
a pair of electrodes coupled to the collar, each electrode being coupled to the collar inside;
an electric connector coupled to the pair of electrodes, the electric connector including a male plug coupled to the pair of electrodes and a female plug, the male plug being selectively engageable with the female plug;
a leash connector coupled to the collar, the leash connector including a first D-ring coupled to the collar outside, a pivot clip selectively engaged with the first D-ring, and a second D-ring coupled to the pivot clip;
a leash coupled to the leash connector, the leash having a distal end coupled to the second D-ring of leash connector and a looped proximal end;
a mid-leash handle coupled to the leash;
a tensiometer coupled within the leash, the tensiometer being in operational communication with the female plug of the electric connector, the tensiometer measuring tensile force within the leash between the distal end and the proximal end;
a feeder wire coupled within the leash, the feeder wire being in operational communication with the tensiometer and extending towards the proximal end of the leash; and
a controller coupled to the leash, the controller being in operational communication with the wire harness of the feeder wire, the controller comprising:
a housing coupled to the leash;
a microcontroller coupled within the housing, the microcontroller being in operational communication with the tensiometer;
a battery coupled within the housing, the battery being in operational communication with the feeder wire and the microcontroller to deliver an electric shock to a pet through the pair of electrodes when the tensiometer senses tensile force within the leash above a preset threshold;
a charging port coupled to the housing, the charging port being in operational communication with the battery;
a power button coupled to the housing, the power button being in operational communication with the battery;
an LED screen coupled to the housing, the LED screen being in operational communication with the microcontroller; a control button coupled to the housing, the control button being in operational communication with the microcontroller to adjust the shock level delivered to the pair of electrodes; and
an indicator light coupled to the housing, the indicator light being in operational communication with the microcontroller.
